(19) United States
(12) Patent Application Publication
(10) Pub. No.: US 2005/0278885 A1
(43) Pub. Date: Dec. 22, 2005

(54) Paint roller

(75) Inventor: Helmut Sauer, Amtzell (DE)

Correspondence Address: BURR & BROWN, PO BOX 7068, SYRACUSE, NY, 13261-7068, US

(73) Assignee: Ciret Holdings AG, Wangen (DE)

(21) Appl. No.: 11/149,983

(22) Filed: Jun. 10, 2005

(30) Foreign Application Priority Data
Jun. 11, 2004 (DE) 10 2004 028 229.3
Aug. 20, 2004 (DE) 10 2004 040 680.4

(51) Int. Cl. B05C 17/02

(52) U.S. Cl. 15/230.11; 492/13; 492/19; 492/47

(57) ABSTRACT

The invention relates to a paint roller having a multi-part bearing which is disposed on a frame and onto which a tubular roll body can be slipped. The bearing here comprises an inner part encompassing the frame and an outer part encompassing the inner part, the inner part and the outer part being able to be twisted in contrarotation and an external diameter of the outer part being able to be enlarged and diminished depending on a twist direction.

### FIELD OF THE INVENTION

The invention relates to a paint roller including a multi-part bearing disposed on a frame.

### BACKGROUND OF THE INVENTION

A paint roller of this type is known, for example, from DE 101 29 479 A1. This paint roller has two two-part bearings disposed on a frame and consisting of a bearing inner race and a bearing outer race, a tubular roll body being able to be slipped onto the bearing outer races. This paint roller construction is also referred to as a so-called cage system. The cage system is characterized in that the bearings form a structural unit with the paint roller frame and the exchangeable paint roller roll consists merely of a tube provided with a covering. In the case of the known paint rollers, the paint roller roll is held on the bearings by a press fit. The use of a press fit between the bearing and the roll body means in the design, however, that a compromise always has to be reached between the desire for a high clamping force and the desire for good ease of fitting and removal. The high clamping force is absolutely necessary to prevent an axial movement of the roll body on the bearings.

The object of the invention is to develop a paint roller having a tubular roll body, in which an axial displacement of the roll body during use of the paint roller is safely prevented and, at the same time, the roll body can be fitted and removed without a large amount of force being required.

### SUMMARY OF THE INVENTION

The paint roller according to the invention has a bearing, which comprises an inner part encompassing the frame and an outer part encompassing the inner part, the inner part and the outer part being able to be twisted in contrarotation and an external diameter of the outer part being able to be enlarged and diminished depending on the twist direction. It is thereby possible, for the tubular roll body to be slipped onto and pulled off from the bearing disposed on the frame, to lessen the external diameter of the bearing or of the outer part of the bearing and thus to reduce a clamping force acting between the bearing and the tubular roll body. On the other hand, through an appropriate positioning of the inner part and the outer part, the paint roller according to the invention allows the external diameter of the outer part to be enlarged and the clamping force acting between the tubular roll body and the bearing to be thereby increased. Thus, for the operation of the paint roller, a clamping force can now be provided which safely prevents an axial migration of the tubular roll body. The core of the invention is thus a bearing whose external diameter is variable, the change in diameter being effected by an alteration of the radial position or of the radial and axial position adopted by the inner part and the outer part of the bearing relative to each other.

According to the invention, the outer part of the bearing is configured as an expandable sleeve and, in particular, as a sleeve having a slot which divides the sleeve. An outer part of this type, which forms a clasp, is easy to make and its external diameter can be altered to a considerable extent.

The invention further envisages that on the inner part there is configured an outer peripheral surface, which has, in the peripheral direction, an increasing or decreasing distance r to a longitudinal axis L of the frame. Such eccentric or camshaft-like shaping of the inner part enables the measure desired for the expansion of the outer part to be easily determined.

With respect to the outer part, the invention envisages that an approximately cylindrical inner peripheral surface is configured there, which, in the peripheral direction, has an approximately constant distance R to the longitudinal axis L of the frame. The enlargement or diminution of the external diameter of the outer part can thus simply be determined by the deviation of the inner part from a cylindrical form, resulting in an easy-to-plan design.

Of course, the invention also envisages a corresponding reverse solution, in which the inner part slides with stops on an inner peripheral surface of the outer part, which surface, in the peripheral direction, has an increasing or decreasing distance to a longitudinal axis of the frame. It is thereby possible, with the above-stated advantages, to alter the external diameter of the outer part through a contrarotational twisting of the inner part and the outer part.

The invention envisages a cooperation of the outer peripheral surface of the inner part with the inner peripheral surface of the outer part, the outer part sliding, with at least one web disposed on its inner peripheral surface, on the outer peripheral surface of the inner part and thereby experiencing a change to the external diameter, and the twisting capability of the inner part and the outer part being limited by a stop disposed on the outer peripheral surface of the inner part, which stop cooperates with the web and blocks the latter. A torsional limitation, which, at the same time, allows the structural parts to be twisted slightly in contrarotation, is thereby realized in a simple manner. This slight twisting capability is also maintained in adverse conditions, since, if paint happens to penetrate between the outer part and the inner part, only small areas stick together and such adhesions can be freed with a reasonable force expenditure.

The invention envisages a twist angle α<360 degrees and, in particular, α<90 degrees. It is thereby possible to support the outer part on the inner part with at least one and, in particular, four webs evenly distributed over the periphery, and thus to achieve an even distribution of the pressing force of the outer part onto the inner wall of the tubular roll body.

An advantageous embodiment envisages that the inner part is provided with a formed-on adjusting means, which allows the inner part to be secured or twisted by the user. The use of an aid for the fitting or removal operation can thus be dispensed with.

According to the invention, it is further envisaged that the internal diameter of the roll body and the external diameter of the outer part which it assumes in the unclamped state are designed as a light press fit. It is thereby possible to slip the roll body onto the outer part with little force and also to twist the roll body with the outer part counter to the inner part and the inner part counter to the roll body and the outer part in order to establish or release clamping. The light press fit serves, above all, to generate the initial radial force between the sleeve and the roll body which is necessary to actuate the clamping mechanism. By a press fit should be understood, within the meaning of the invention, not only a fit in which two cylindrical contacting surfaces lie fully one-against-the-other, but any cooperation of two structural parts which are slipped one-inside-the-other and which have a punctiform, linear or planar frictional engagement with the other.

With regard to the desired light press fit between the roll body and the outer part, it is advantageous to provide the peripheral surface of the outer part at least partially with an antislip coating and to encase the outer part with at least one rubber ring.

One embodiment of the invention envisages that the tubular roll body is supported on the clamping bearing, consisting of an outer part and an inner part, and on a pilot bearing disposed on a free end of the frame. It is thereby possible to exchange the bearings individually, where necessary, in the event of a repair.

A further embodiment envisages that the inner part of the clamping bearing is configured as a grid tube, which extends the entire length of the roll body and forms a constituent part of a satellite bearing disposed at the free end of the frame. Such a design prevents tilting when the tubular roll body is slipped onto the basic structure of the paint roller and thus facilitates assembly of the roll body.

The invention also envisages that the contact surface between the outer part and the roll body is limited to, maximally, one-quarter of the length of the roll body. This prevents excessive pull-off forces should the outer part and the roll body become stuck together.

According to the invention, an inner part, configured as a cone, has a contacting surface having a thread. An outer part, configured as a clasp, a slotted sleeve, or a hollow cylinder with slot, bears on a threaded conical inner contacting surface. The threads of the inner and outer parts cooperate allowing the diameter of the outer part to be determined by the position which the outer part and the inner part adopt relative to each other. With a clamping bearing of this type, the clamping force can be finely set and large clamping forces can be obtained with little exertion.

The invention envisages that the threads of the inner part and of the outer part are configured as trapezoidal threads, guaranteeing smooth running when an adjustment is made. Of course, the invention also provides for the use of other motion-transmitting threads.

Finally, the invention envisages that the roll body is supported against the frame indirectly via an annular rim formed on the inner part or directly. This prevents the roll body, in an effective and simple manner, from being displaced by the outer part in an axial direction (x) when the clamping force is generated.

### BRIEF DESCRIPTION OF THE DRAWINGS

Further details of the invention are described in the drawing with reference to diagrammatically represented illustrative embodiments. FIG. 1: shows a top view of a first embodiment of a paint roller; FIG. 2: shows a perspective representation of the paint roller represented in FIG. 1, without tubular roll body;

FIGS. 3a, 3b: show a section through the paint roller, corresponding to the sectional line III-III represented in FIG. 1, in two different positions of the bearing;

FIG. 4: shows a longitudinal section through the paint roller, corresponding to the sectional line IV-IV represented in FIG. 1;

FIG. 5: shows a further perspective representation of the paint roller with the bearing represented in a cut-open state;

FIG. 6: shows an enlarged representation of the cut-open bearing;

FIG. 7: shows a representation according to FIG. 6 without being cut open;

FIG. 8: shows a top view of a second embodiment of a paint roller without representation of the roll body;

FIG. 9: shows a side view of the paint roller represented in FIG. 8;

FIG. 10: shows a perspective representation of the paint roller represented in FIGS. 8 and 9;

FIGS. 11 and 12: show perspective representations of the tubular inner part;

FIG. 13: shows a perspective representation of the paint roller with bearings represented in the form of sections;

FIG. 14: shows an enlarged detailed view of the clamping bearing from FIG. 13;

FIG. 15: shows an enlarged detailed view of the satellite bearing from FIG. 13;

FIG. 16: shows a perspective representation of a third embodiment of a paint roller;

FIG. 17: shows a perspective representation of the paint roller shown in FIG. 16, with a cut-open roll body;

FIGS. 18, 19: show detailed views of FIG. 17;

FIGS. 20, 21: show perspective sectional representations of a clamping bearing of the paint roller in different positions; and

FIGS. 22, 23: show perspective representations of the clamping bearing in different positions.

### DETAILED DESCRIPTION OF THE INVENTION

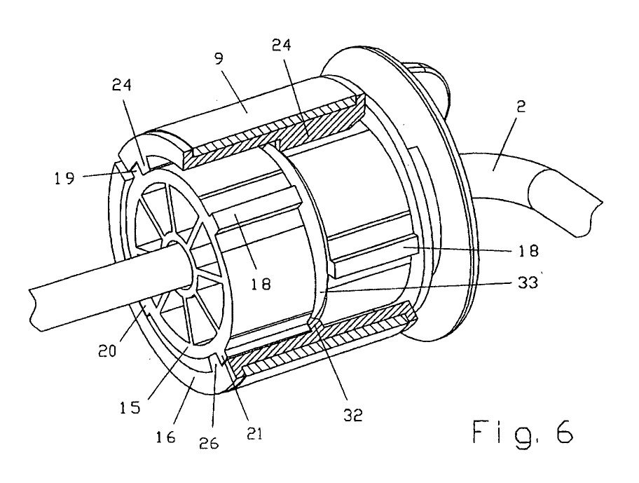

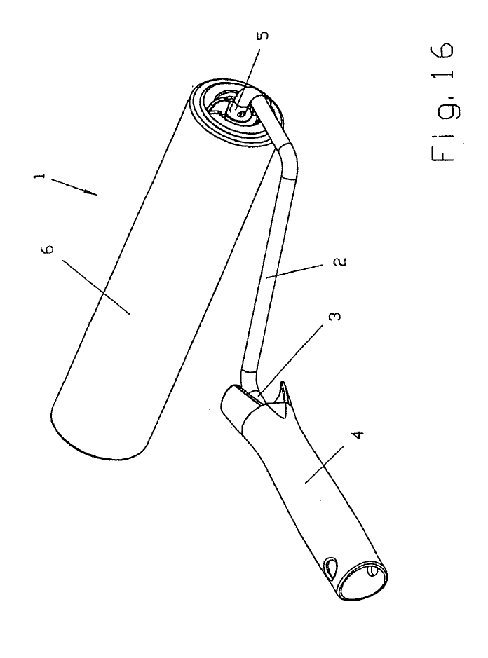

The figures show three embodiments of a paint roller according to the invention, FIGS. 1 to 7 showing a first embodiment, FIGS. 8 to 15 a second embodiment, and FIGS. 16 to 23 a third embodiment.

In FIG. 1, a top view of a paint roller 1 is represented. The paint roller 1 comprises a bent frame 2, which, at a first free end 3, has a handle 4. At a second free end 5 of the frame 2 there is disposed a tubular roll body 6, which is borne by two bearings 7 and 8 (see FIG. 2). Here the bearing 7 is configured as a clamping bearing 9 and the bearing 8 as a pilot bearing 10 with a sealing ring (not represented).

In FIG. 2, which shows the paint roller 1 represented in FIG. 1 in perspective view without the tubular roll body, wings 11 disposed on the pilot bearing 10 are also visible, by which the tubular roll body 6 (not shown in FIG. 2) is borne in clamping arrangement. FIG. 2 thus shows a structural unit B which is somewhat similar to that of a so-called cage system paint roller and which is completed by the roll body (not represented). The clamping bearing 9 and the pilot bearing 10 are respectively secured by a non-visible retaining washer against an axial displacement on the free end 5 of the frame 2.

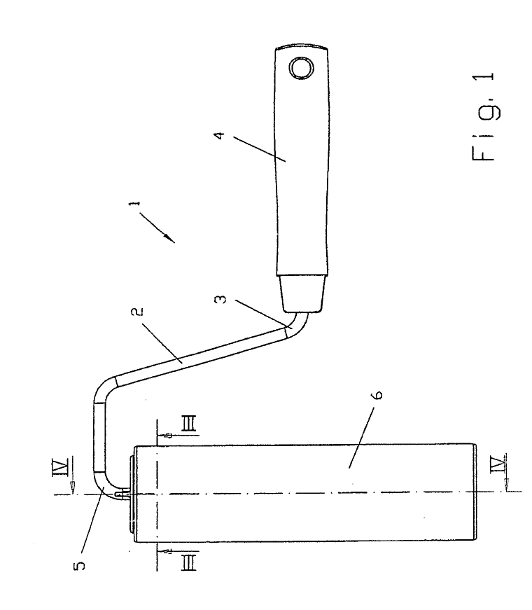

FIGS. 3a and 3b show a section, along the sectional line III-III represented in FIG. 1, through the tubular roll body 6 in the region of the clamping bearing 9. Here, the clamping bearing 9 is shown in FIG. 3a in a release position I, in which the roll body 6 can be pulled off from the clamping bearing 9 or slipped onto the latter. FIG. 3b shows the clamping bearing 9 in a clamping position II, in which the roll body 6 is fixed on the clamping bearing 9.

FIG. 3a shows in detail a roll body 6, which is constructed in two parts and consists of a cylindrical inner tube 12 and a coating 13, which is shrunk thereon. As the coating 13, foam, for example, can be used. As a result of the diagrammatic form of representation chosen for FIGS. 3a and 3b, an air gap 14 is clearly discernible between the roll body 6 and the clamping bearing 9, which air gap shows that these two structural parts are decoupled one from the other and the roll body 6 can be pulled off from the clamping bearing 9. The clamping bearing 9 is essentially composed of an inner part 15 and an outer part 16. The inner part 15 is mounted on the frame 2 so as to be freely rotatable about the longitudinal axis L thereof. In addition, the inner part 15 has an outer peripheral surface 17, on which four stops 18 to 21 are disposed. Between the stops 18 to 21, the outer peripheral surface 17 has respectively a distance to the longitudinal axis L which increases from r1 to r2. The outer part 16, in the region of an outer peripheral surface 22, is covered by an antislip coating S and, on an inner peripheral surface 23, bears four webs 24 to 27. In addition, the outer part 16 is divided by a slot 28 running parallel to the longitudinal axis L. This slot 28 allows an expansion of the outer part 16 from a small diameter D1 to a large diameter D2 (compare FIG. 3b).

The expansion of the outer part 16 is effected by a rotation of the inner part 15 in a rotational direction w1 by a rotation angle α of about 80° (see FIG. 3b). Here, the webs 24 to 27 slide on the outer peripheral surface 17 of the inner part 15 and the stops 18 to 21 slide on the inner peripheral surface 23 of the outer part 16. The outer part 16 forming a sleeve 29 is expanded by virtue of the increasing distance r1 to r2 of the outer peripheral surface 17 of the inner part 15. The maximally expanded outer part 16 with the maximally expanded antislip coating S is represented in FIG. 3b. In this clamping position II, the air gap 14 still present in FIG. 3a is closed. In the clamping position II with the diameter D2, the outer part 16 assumes a diameter ensuring a press fit which makes it impossible for the roll body 6 to be slipped off under normal conditions. A relocation of the clamping bearing 9 from the clamping position II into the release position I is effected by a twisting of the inner part 15 in a rotational direction w2 counter to the outer part 16 and the roll body 6. Alternatively, for the unclamping of the clamping bearing 9, a twisting of the outer part 16 with the roll body 6 in the rotational direction w1 counter to the inner part 15 is, of course, possible.

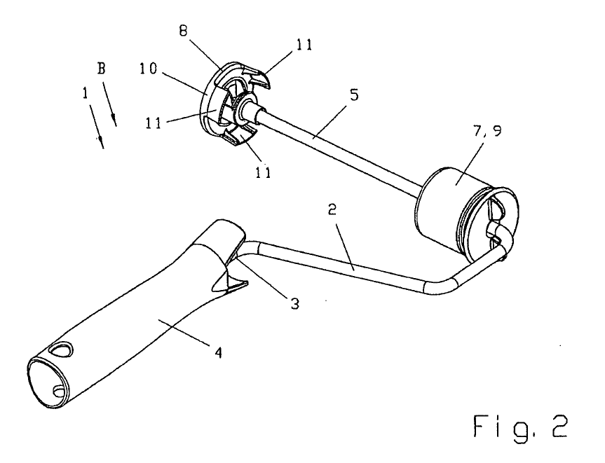

FIG. 4 illustrates a longitudinal section roughly corresponding to a sectional line IV-IV represented in FIG. 1, a representation of the pilot bearing 10 having been omitted from the sectional view. The sectional view shows the clamping bearing 9 seated on the frame 2, the clamping bearing 9 being in the release position I shown in FIG. 3a and thus the air gap 14 being formed to the roll body 6, which air gap allows the removal of the roll body. The longitudinal section shows a step-shaped configuration of the inner part 15 and of the outer part 16. In addition, in the longitudinal section, adjusting means 30 are discernible, which are formed on the inner part 15 via webs 31 and allow a manual rotation of the inner part 15 on the frame 2 so as to be able to switch the clamping bearing 9 from the release position I to the clamping position II (see FIG. 3b). The air gap 14 represented in FIGS. 3a and 4, which, in the release position I, is shown between the outer part 16 and the roll body 6, serves, in these diagrammatic representations, merely to pictorially illustrate the release position. In a fully functional paint roller 1, the outer part 16 and the roll body 6, in a first embodiment, are in light mutual contact, even in the release position, so that the outer part 16 can rest against the roll body 6, which, if need be, is held by hand, and so that the outer part 16, when the switch is made from the release position I to the clamping position II, is not transported by the inner part 15. Additionally, to counteract possible movement caused by inertia of the outer part 16, a positive-locking support of the outer part 16 against the roll body 6 is also envisaged. This can be achieved, for example, by an eccentric shaping or a wedge-shaft-like toothing between the two structural parts. According to a further embodiment, it is envisaged that the cohesion between the outer part and the roll body 6 is realized by at least one knob or rib. In such an embodiment, a gap between the structural parts would then, of course, be visible in the sectional view in some areas.

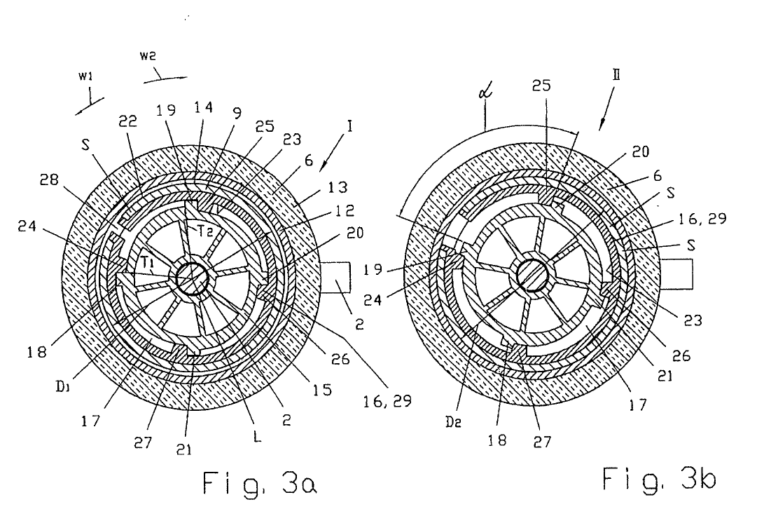

FIG. 5 shows a further perspective representation of the structural unit B of the paint roller 1, the paint roller 1 being shown with the clamping bearing 9 represented in a cut-open state.

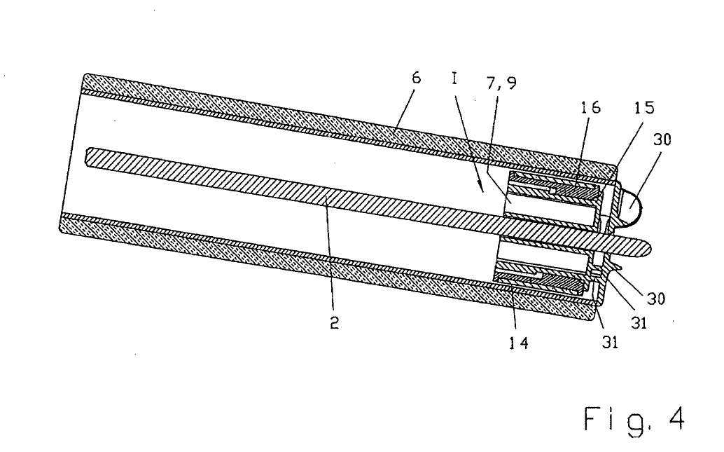

FIG. 6 shows an enlarged representation of the clamping bearing 9 represented in FIG. 5. It can be seen from this how the lateral cohesion of the inner part 15 and the outer part 16 is effected. The outer part 16 engages, with lugs 32 distributed over the periphery, in a circumferential groove 33 of the inner part 15. An offset arrangement of the stops 18 to 21 and of the webs 24 to 27, which arrangement is not discernible in the sectional representations in FIG. 3a and FIG. 3b, allows a more even distribution of the force with which the inner part 15 clamps the outer part 16 in the clamping position II shown in FIG. 3b. Despite this distribution of the force to eight regions, the path of adjustment of approximately a ¼-revolution is maintained.

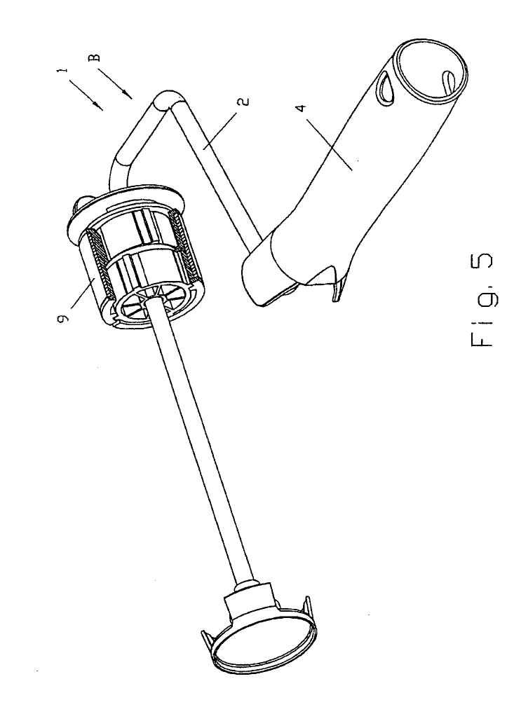

FIG. 7 shows the clamping bearing 9 represented in FIG. 6, in closed form. In this representation, the cooperation of the stop 18 with the web 27, which cooperation is not visible in FIG. 6, can also be seen.

FIG. 8 shows a second embodiment of a paint roller 1. Of the paint roller 1, only one structural unit B is represented. The representation of a roll body 6 has been dispensed with. At a second free end 5 of the frame 2, two bearings 7 and 8 are visible. The bearings 7, 8 are realized as a clamping bearing 9 and as a satellite bearing 34, an inner part 15 of the clamping bearing 9 being realized as a grid tube 35 and serving as a constituent part of both bearings 7 and 8.

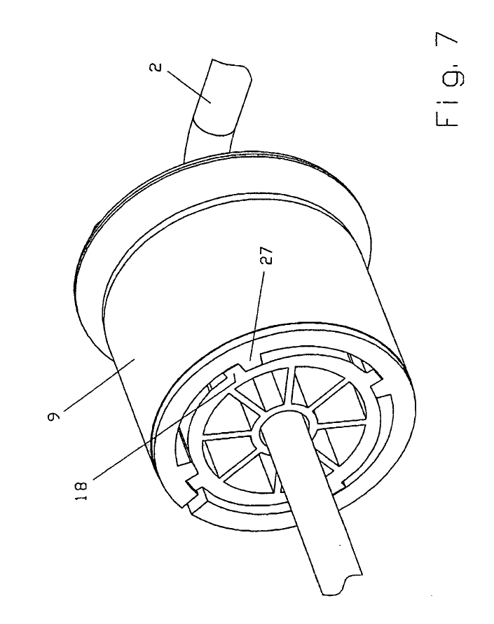

FIG. 9 shows a side view, from an arrow direction IX, of the paint roller represented in FIG. 8.

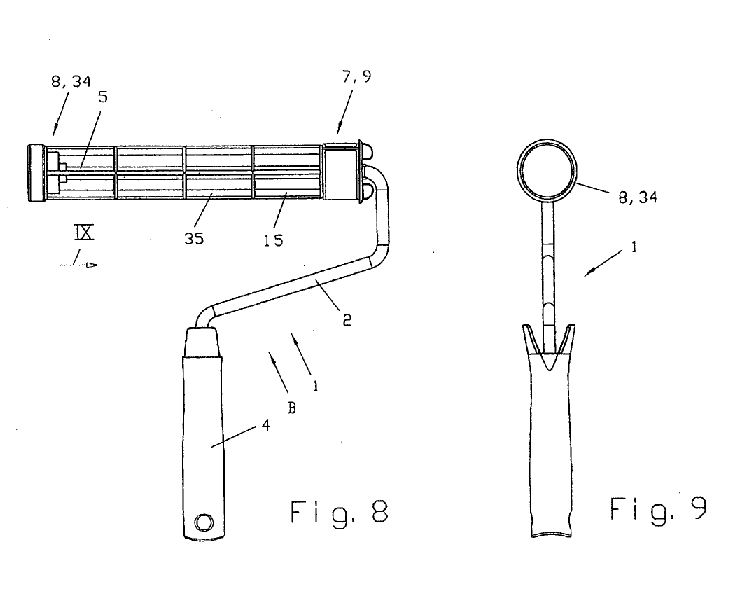

FIG. 10 shows a perspective view of the structural unit B, represented in FIGS. 8 and 9, of the paint roller 1. In this representation, the frame 2, on which bearings 7 and 8 run, can be seen running through the grid tube 35. In addition, analogous to the first embodiment of the paint roller, adjusting means 30 are discernible, which are connected to the grid tube 35 and the inner part 15 respectively.

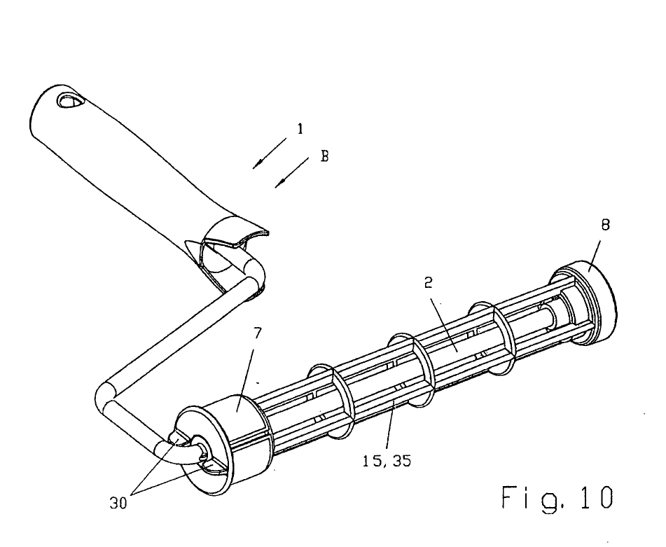

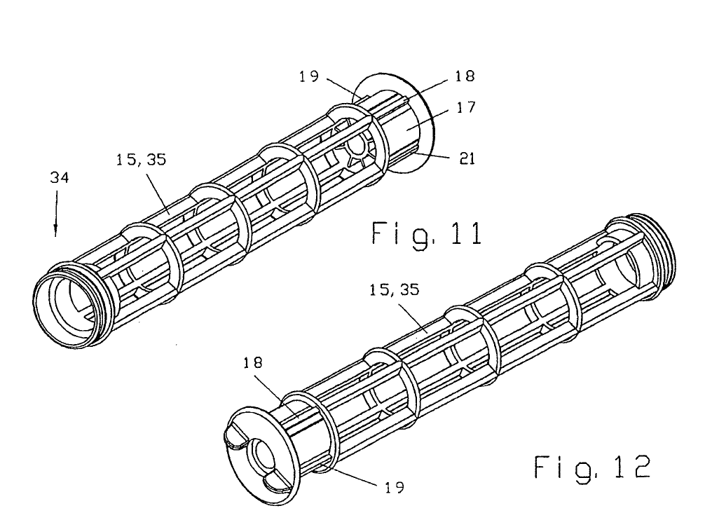

FIGS. 11 and 12 show the inner part 15 or grid tube 35 in two perspective views. In these representations, stops 18, 19 and 21 are discernible, which are disposed on an outer peripheral surface 17 of the inner part 15. In the region of the satellite bearing 34, the inner part 15 is shaped like a cylinder.

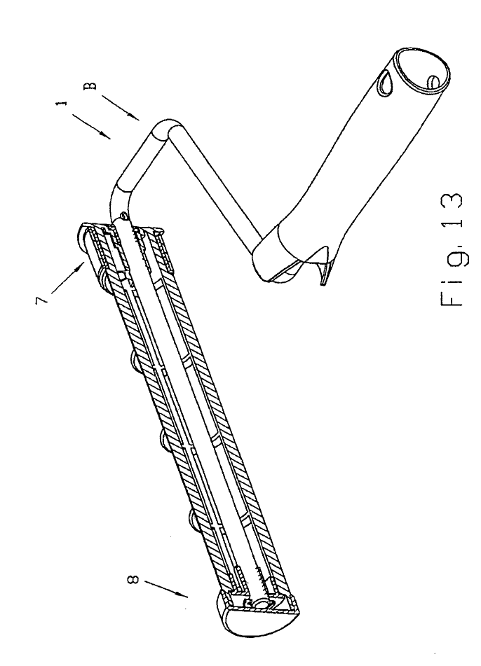

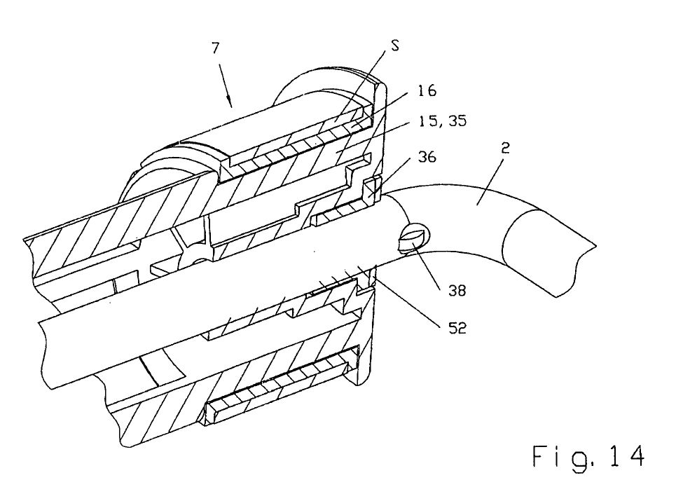

FIG. 13 shows a perspective representation of the structural unit B of the paint roller 1 with bearings 7 and 8 represented in cut-open state. In FIG. 14, a corresponding enlargement of the bearing 7 is depicted. On the inner part 15, which is configured as a grid tube 35, there is guided an outer part 16 having an antislip coating S. Unlike the first embodiment, the inner part 15 is mounted on the frame by means of a sliding sleeve 36. A U-washer 52 protects the sliding sleeve 36 against a crimp 38 located on the frame 2 and holds the bearing 7 in position.

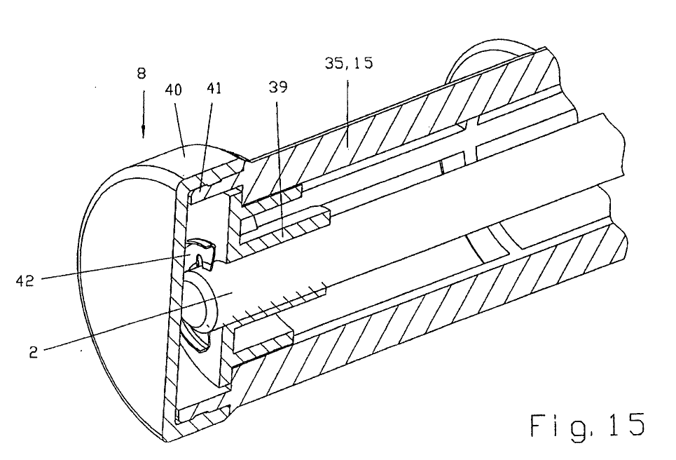

In FIG. 15, the bearing 8 is represented on an enlarged scale in accordance with the representation in FIG. 13. A spacing sleeve 39 keeps the grid tube 35 at a distance from the frame 2. The bearing 8 is completed by a cap 40, which is seated on a cylindrical projection 41 of the grid tube 35. The bearings 7 and 8 are prevented from being pulled off by a spring clip 42 seated on the frame 2.

In FIG. 16, a third embodiment of a paint roller 1 is represented in perspective view. The paint roller 1 comprises a frame 2, which, at a first free end 3, has a handle 4. At a second free end 5 of the frame 2 there is disposed a tubular roll body 6.

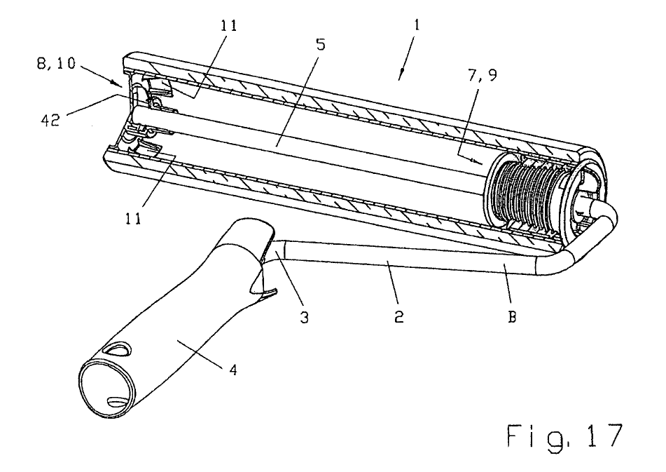

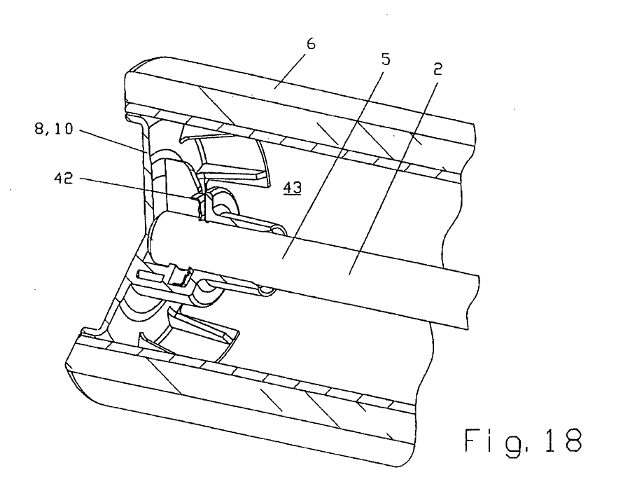

In FIG. 17, the paint roller 1 shown in FIG. 16 is represented in a cut-open state. The cut-open roll body 6 is borne by two bearings 7 and 8, represented in cut-open state. Here, the bearing 7 is configured as a clamping bearing 9 and the bearing 8 as a pilot bearing 10. In addition, wings 11 disposed on the pilot bearing 10 are visible, by which the roll body 6 is borne in clamping arrangement. FIG. 17 thus again shows a structural unit B which is typical of the cage system and which is completed by the roll body 6 to give the paint roller 1. The clamping bearing 9 and the pilot bearing 10 are respectively secured by a clamping or retaining washer 42 (see FIG. 17) against an axial displacement on the frame 2 (see also FIG. 18).

In FIG. 18, the pilot bearing 10 shown in FIG. 17 is represented in a detailed view. Through a lid-shaped configuration of the pilot bearing 10, a cavity 43, which is formed between the frame 2 and the roll body 6, is sealed against paint penetration.

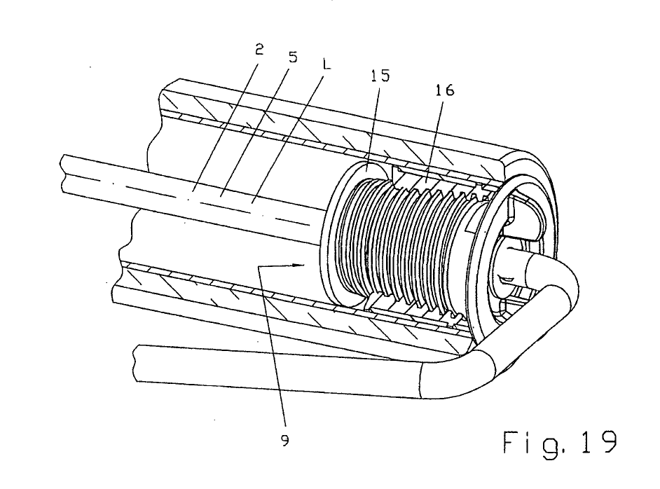

In FIG. 19, the clamping bearing 9 shown in FIG. 17 is represented in a detailed view. The clamping bearing 9 comprises an inner part 15 and an outer part 16, the inner part 15 being held on the free end 5 of the frame 2 by the aforementioned, non-visible retaining washer so as not to be displaced on the frame 2 in the direction of a longitudinal axis L.

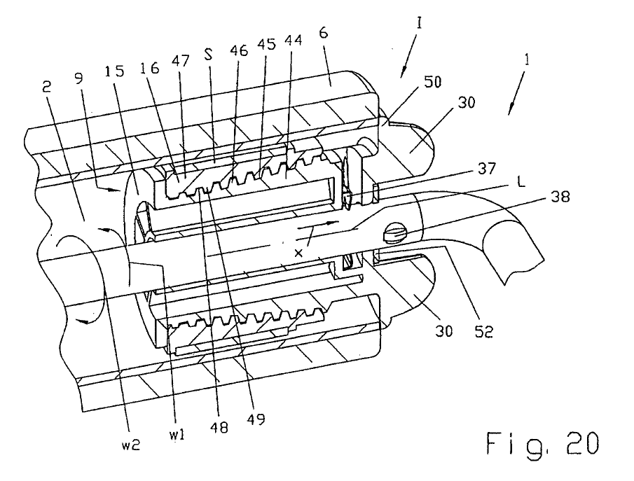

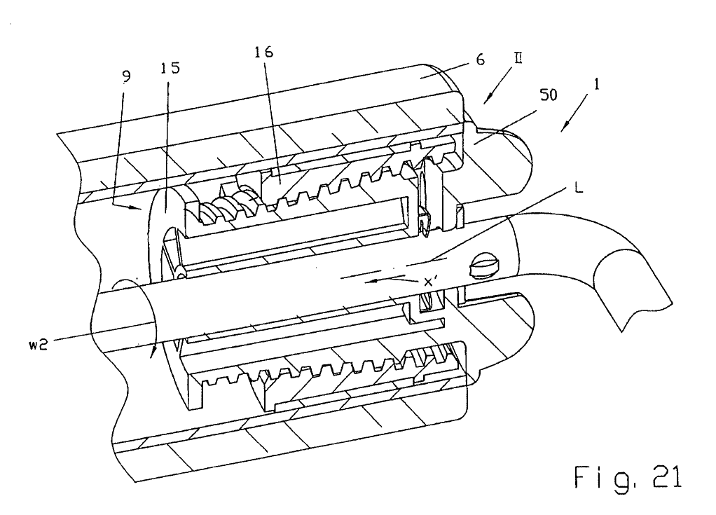

In FIG. 20, there is now portrayed an enlarged sectional representation in the region of the clamping bearing 9 through the paint roller 1 shown in FIG. 16. In this representation, the retaining washer 37, too, is visible, which fixes the inner part 15 on the frame 2 in the axial direction. Parallel to the retaining washer 37, a U-washer 52 is mounted on the frame 2, which protects the adjusting means 30 against damage from a crimp 38 and secures the position of the clamping bearing 9. The inner part 15 is realized as a cone 44, which is rotatably mounted on the frame 2 and which bears, on a conical contacting surface 45, a trapezoidal thread 46. The outer part 16 is realized, in accordance with the inner part 15, as a slotted hollow cylinder 47, which bears, on a conical inner contacting surface 48, a trapezoidal thread 49, which cooperates with the trapezoidal thread 46 of the inner part 15. Via an antislip coating S fastened on the slotted hollow cylinder 47, the outer part 16 is in frictionally engaged contact with the roll body 6. The inner part 15 can be rotated via formed-on wings or adjusting means 30 about the frame 2 and the longitudinal axis L. A rotation of the inner part 15 in an arrow direction w1 about the longitudinal axis L brings about an axial motion of the outer part 16 in an arrow direction x. A prerequisite for this is that the outer part 16 is supported against the roll body 6 and that the roll body 6 is stationary. A roll body 6, which jointly rotates more slowly than the inner part 15, slows the motion of the outer part 16 in the arrow direction x. A roll body 6, which rotates in an opposite arrow direction w2, accelerates the motion of the outer part in the arrow direction s. The outer part 16 is thus moved, relative to the inner part 15 and to the roll body 6, out of the release position shown in FIG. 20 into the clamping position II represented in FIG. 21. In the clamping operation, the roll body 6 alters its position relative to the inner part 15 and to the frame 2 at most minimally, since it rests, counter to the pushing force of the outer part 16, against an annular rim 50 of the inner part 15. From the clamping position II shown in FIG. 21, the outer part 16 can be moved, by a rotation of the inner part 15 in the rotational direction w2, back into the release position I shown in FIG. 20. For this purpose, the outer part 16 moves between the roll body 6 and the inner part 15 in an arrow direction x′. Insofar as the outer part 16 in the process transports the roll body 6 in the arrow direction x′, this facilitates the deliberate pulling-off of the roll body 6.

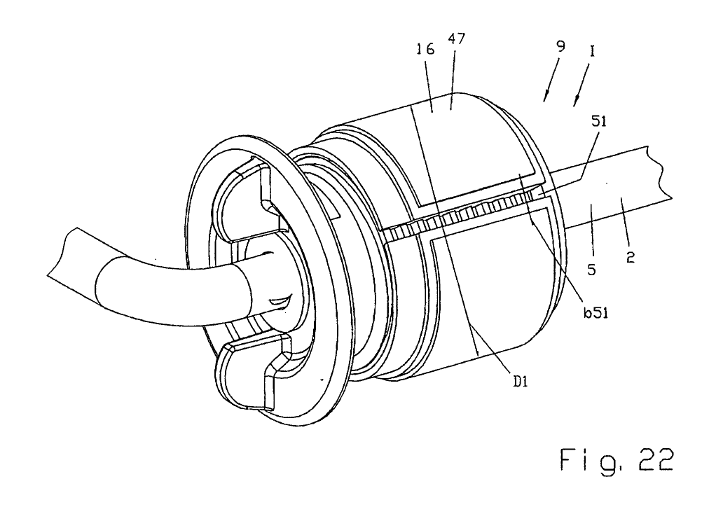

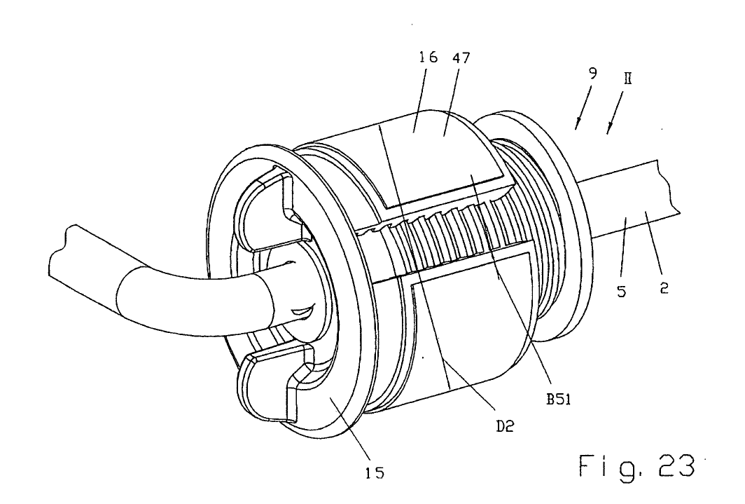

In FIGS. 22 and 23, there are shown two detailed views of the clamping bearing 9 without slipped-on roll body 6, corresponding with the representations of FIGS. 20 and 21. FIG. 22 shows the clamping bearing 9 in the release position I. In this position, the slotted hollow cylinder 47 of the outer part 16, configured as a clasp, has only a relatively narrow gap 51 with a width b51 and a small diameter D1. FIG. 23 shows the clamping bearing 9 in the clamping position II, which is achieved by a contrarotational twisting of the inner part 15 and of the outer part 16. The twisting leads to a change in the axial and the radial position which the parts 15 and 16 adopt relative to each other. In the clamping position II, the slotted hollow cylinder 47 forming the outer part 16 is expanded to a large diameter D2 and shows a wide slot or gap 51 with a large width B51. FIGS. 16 to 23 should be regarded, with respect to the represented dimensions, as diagrammatic representations. An increase in diameter ΔD=D2−D1 which the outer part 16 experiences during the expansion should be tailored, of course, to the dimensions of the structural parts and to the properties of the materials used for the individual structural parts.

The invention is not limited to represented or described illustrative embodiments, but comprises refinements of the invention within the scope of the patent claims. In particular, the invention also provides for the use of a second clamping bearing.

### REFERENCE SYMBOL LIST

1 paint roller

2 frame

3 first free end of 2

4 handle

5 second free end of 2

6 tubular roll body

7, 8 bearings

9 clamping bearing

10 pilot bearing

11 wings on 8 and 10

12 inner tube of 6

13 coating of 6

14 air gap between 6 and 16

15 inner part of 9

16 outer part of 9

17 outer peripheral surface of 15

18 to 21 stop on 17

22 outer peripheral surface of 16

23 inner peripheral surface of 16

24 to 27 web on 16

28 slot in 16

29 sleeve with slot

30 adjusting means on 15

31 web on 15

32 lug on 16

33 groove in 15

34 satellite bearing

35 grid tube

36 slide sleeve for 15

37 washer

38 crimp on 2

39 spacing sleeve for 15

40 cap

41 cylindrical projection of 15 and 35

42 spring clip

43 cavity between 6 and 2

44 cone

45 contacting surface of 44

46 trapezoidal thread of 44 on 45

47 slotted hollow cylinder

48 conical inner contacting surface of 47

49 trapezoidal thread of 47 on 48

50 annular rim of 15

51 gap of 47

52 U-washer for 15

α twist angle

B structural unit

b51 small width of 51

B51 large width of 51

D1, D2 diameter of 16

ΔD diameter increase of 16

L longitudinal axis

R radius of 23

r1, r2 radius of 17

S antislip coating on 16

w1, w2 rotational direction

x, x′ axial motional directions of 16

I release position

II clamping position

1. A paint roller having a multi-part bearing which is disposed on a frame and onto which a tubular roll body can be slipped, wherein the bearing comprises an inner part encompassing the frame and an outer part encompassing the inner part, the inner part and the outer part being rotatable relative to one another such that an external diameter of the outer part changes depending upon the direction in which the inner and outer parts are rotated.

2. A paint roller as claimed in claim 1, wherein the outer part is an expandable sleeve.

3. A paint roller as claimed in claim 2, further comprising a slot which divides the sleeve.

4. A paint roller as claimed in claim 1, wherein the inner part further comprises an outer peripheral surface which, in the peripheral direction, has at least one increasing or decreasing radial distance relative to a longitudinal axis of the frame.

5. A paint roller as claimed in claim 4, wherein the outer part further comprises an inner peripheral surface which, in the peripheral direction, has an approximately constant radial distance relative to the longitudinal axis of the frame.

6. A paint roller as claimed in claim 1, wherein the outer part further comprises an inner peripheral surface which, in the peripheral direction, has at least one increasing or decreasing radial distance relative to a longitudinal axis of the frame.

7. A paint roller as claimed in claim 6, wherein the inner part further comprises an outer peripheral surface which, in the peripheral direction, has an approximately constant radial distance relative to the longitudinal axis of the frame.

8. A paint roller as claimed in claim 5, wherein the outer peripheral surface of the inner part cooperates with the inner peripheral surface of the outer part.

9. A paint roller as claimed in claim 5, further comprising at least one web disposed on the inner peripheral surface of the outer part and on the outer peripheral surface of the inner part, and wherein the external diameter of the outer part is variable depending on the rotational direction.

10. A paint roller as claimed in claim 9, wherein the inner part further comprises, on its outer peripheral surface, at least one stop, with which the outer part can be blocked in its rotation by means of the web.

11. A paint roller as claimed in claim 1, wherein the inner part and the outer part are rotatable relative to one another by an angle less than 360°.

12. A paint roller as claimed in claim 1, wherein the inner part and the outer part are rotatable to one another by an angle less than 90°.

13. A paint roller as claimed in claim 1, further comprising adjusting means for rotating the inner part about the frame relative to the outer part.

14. A paint roller as claimed in claim 1, wherein a light press fit is created between the roll body and the outer part in an unclamped state.

15. A paint roller as claimed in claim 1, further comprising an antislip coating located on an outer peripheral surface of the outer part.

16. A paint roller as claimed in claim 1, further comprising a rubber ring encasing the outer part.

17. A paint roller as claimed in claim 1, further comprising a pilot bearing disposed on a free end of the frame for supporting the roll body.

18. A paint roller as claimed in claim 1, wherein the inner part is a tube extending approximately over the length of the roll body and forming a part of a satellite bearing disposed at a free end of the frame.

19. A paint roller as claimed in claim 1, wherein the outer part extends over maximally ¼ of the length of the roll body.

20. A paint roller as claimed in claim 1, wherein the inner part further comprises a conical contacting surface having a first thread and the outer part further comprises a conical inner contacting surface having a second thread, which cooperates with the first thread of the inner part, wherein the outer part is a slotted hollow cylinder that is expandable by rotating the inner part.

21. A paint roller as claimed in claim 20, wherein the threads are trapezoidal threads.

22. A paint roller as claimed in claim 1, wherein the inner part supports the roll body in a direction along a longitudinal axis of the frame.

23. A paint roller as claimed in claim 1, wherein the inner part and the outer part can be mutually displaced axially along a longitudinal axis of the roll body.
